(19) United States
(12) Patent Application Publication
(10) Pub. No.: US 2010/0272968 A1
(43) Pub. Date: Oct. 28, 2010

(54) Polyurethan Resins for Nitrocellulose Inks

(75) Inventor: Dharakumar Metla, Chalfont, PA (US)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/743,450

(22) PCT Filed: Nov. 8, 2008
(86) PCT No.: PCT/EP2008/009439

§ 371 Date: Jul. 9, 2010

Related U.S. Application Data
(60) Provisional application No. 60/988,934, filed on Nov. 19, 2007.

(51) Int. Cl. C08L 75/04; B32B 27/08

(52) U.S. Cl. 428/195.1; 524/538

(57) ABSTRACT

A polyurethane resin which is particularly suitable for use in nitrocellulose-based printing inks for laminating packaging applications is described. The polyurethane resin provides the inks with excellent extrusion and adhesive properties, which inks are suitable for use in laminated products for packaging applications.

### CROSS-REFERENCE TO RELATED APPLICATIONS

This application is the National Stage entry of PCT/EP2008/009439 filed Nov. 8, 2008, which claims priority to U.S. Provisional application No. 60/988,934, filed Nov. 19, 2007, both of which are incorporated herein by reference in their entireties.

### FIELD OF THE INVENTION

The invention relates to a polyurethane resin, its preparation, a nitrocellulose ink composition containing the polyurethane resin for flexographic or gravure printing applications, and a laminate printed with the ink composition containing the polyurethane resin.

### BACKGROUND OF THE INVENTION

Recent diversification in package bags or containers has required a high degree of performance for printing inks or coating agents used for the ornamentation or surface protection thereof. Such inks or coating agents should exhibit excellent adhesiveness for various kinds of plastic films, and blocking resistance.

For instance, nitrocellulose-polyurethane based printing inks for plastic films are utilized to provide improved printability, adhesion to a wider range of films, and better blocking resistance and heat resistance than conventional ones.

Especially, in the field of food packaging, bags or containers made of laminated film materials are used for the reasons that they are sanitary and their contents do not come in direct contact with the ink, and to provide a satisfactory appearance as a high grade of printed products.

Generally there are two methods for producing such laminated film materials. One is an extrusion laminating method, wherein a plastic film substrate is printed with an ink, and if necessary, a primer is applied onto the inked surface; then a molten resin such as polyolefin is extruded onto the inked surface. Another method is an adhesive laminating method, wherein an adhesive is applied onto the inked surface of the plastic film substrate, and a plastic film is then laminated onto the same surface. Accordingly, the laminating inks must possess excellent adhesion to the printing substrate as well as to the film to be laminated.

Inks for printing on flexible substrates (e.g., synthetic polymer films) and laminating inks (i.e., inks that are placed between two substrates and that provide the traditional properties of an ink resin, and desirably augment the adhesion between the two substrates) are therefore of continuing and growing interest in the field of flexible packaging.

Nitrocellulose (NC) is a major dispersing (grinding) resin for ink pigments. NC pigment bases are used in flexible package printing by flexographic and gravure processes. NC-based inks are versatile but lack flexibility. This lack of flexibility can cause poor adhesion and performance when printed on flexible films (substrates). Therefore, it is necessary to add a plasticizer to NC bases to increase flexibility and performance.

Current plasticizers such as phthalates, polyamides, and low molecular weight polyurethanes have demonstrated limitations when used in NC-based inks, such as migration, compatibility, solubility and low lamination bond strengths.

It is therefore desirable to provide a semi-film forming polyurethane resin that has good compatibility with NC; is soluble in alcohol and ester solvents, and blends thereof; and, when incorporated into an NC-based ink, is suitable for flexographic and gravure printing processes. The NC-polyurethane inks should provide good extrusion and adhesive lamination performance on multiple flexible substrates.

### DETAILED DESCRIPTION OF PREFERRED EMBODIMENTS

By way of the invention, semi-film forming polyurethane resins from the addition-condensation polymerization of polyisocyanates with polyalcohols, which are further chain extended with diol or diamine are provided, which resins exhibit the desired improved extrusion and adhesion lamination performance desired for NC-based inks.

By way of the invention, a semi-film forming polyurethane resin for use in an NC-based ink composition for laminate packaging applications is provided, which polyurethane resin advantageously provides good extrusion and adhesive properties, which properties provide good lamination bond strength to the ink composition.

The subject matter of the present invention is the use of a polyurethane resin for a nitrocellulose-based ink for laminated packaging applications, which resin comprises the reaction product of a polyisocyanate and a polyalcohol to form an isocyanate-terminated prepolymer, which prepolymer is chain extended with a diol or a diamine to form the polyurethane resin, said polyurethane resin being compatible with nitrocellulose and having adhesive properties which provide a lamination bond strength of greater than about 200 g/inch peeled at 300 mm/min

An aspect of the invention then is a semi-film forming polyurethane resin, which resin comprises the reaction product of a polyisocyanate and a polyalcohol to form an isocyanate-terminated prepolymer, which prepolymer is extended with a diol or diamine to form the polyurethane resin of the invention. The resin of the invention exhibits good compatibility with NC; is soluble in alcohol and ester solvents, and blends thereof; and is suitable for use in NC-based inks for flexographic and gravure printing processes.

The polyurethane resin of the invention possesses good lamination bond strength, while also maintaining solubility in alcohol, ester and alcohol/ester blends, adhesion to substrates, block resistance, heat resistance, and stable rheology.

Another aspect of the invention is an NC-based printing ink composition suitable for laminating applications containing the polyurethane resin, a colorant; and an organic solvent, which ink composition is suitable for flexographic or gravure packaging applications. The ink composition can include additional components such as an adhesion promoter.

Inks containing the polyurethane resin of the invention exhibit good bond strength when printed on films, particularly when used as laminating inks.

Accordingly, another aspect of the present invention is a laminate of two or more flexible film substrates having a surface of one of the substrates printed with the ink composition of the invention, wherein the printed image remains substantially unchanged and intact under typical packaging conditions due to the good bond strength provided by the presence of the polyurethane resin of the invention in the ink composition.

Other than in the operating examples, or where otherwise indicated, all numbers expressing quantities of ingredients or reaction conditions used herein are to be understood as modified in all instances by the term “about.”

Polyurethane resins are described herein which are useful as binders in formulating NC-based printing inks for packaging applications, and as adhesives in preparing laminates and laminated products used in flexible packaging applications.

The semi-film forming polyurethane resins of the invention are soluble in an organic solvent, such as alcohol, ester and alcohol/ester blends, and are particularly compatible with and useful in formulating NC-based laminating inks used in packaging applications. The resins' solubility in alcohol, ester and alcohol/ester blends allows for the formulation of ink or coating compositions for flexographic and gravure applications with only minor formulation modifications.

The term “semi-film forming” shall be understood to mean neither film-former nor plasticizer.

The term “compatible with nitrocellulose” shall be understood to mean when NC solution and polyurethane solution are mixed at different blend ratios, the blends are clear and stable without any color development, precipitation, or gelation.

The term “lamination bond strength” shall be understood to mean the force in grams per linear inch required to pull apart the primary and secondary substrates in the lamination. Preferably, the lamination bond strength of the polyurethane resins of the present invention is greater than about 200 g/inch peeled at 300 mm/min (which corresponds to 1.2 N/15 mm peeled at 300 mm/min)

NC-based laminating ink and coating compositions formed with the polyurethane resin of the invention exhibit excellent extrusion bond strengths, block resistance, printability, resolubility, and superior adhesion on a wide variety of films (substrates), as compared to laminating inks and coatings made with the conventional and commercially available resin binder systems described above.

The polyurethane resin of the invention is prepared by reacting an aliphatic, cycloaliphatic, aromatic or alkylaromatic diisocyanate with a polyalcohol to provide an isocyanate-terminated polyurethane prepolymer. The prepolymer is then chain extended using a diol or diamine to form urethane/urea linkages.

Typically, the resulting polyurethane resin has a number average molecular weight of from about 20,000 to 120,000 daltons, preferably from about 30,000 to 80,000 daltons.

The viscosity of the polyurethane resins of the invention range from about 500 to about 5,000 cps at 25° C. (which corresponds to 500 to about 5,000 mPa·s at 25° C.).

The solids range from about 35 to about 60% and the Gardner color is less than 4.

Any diisocyanate of the formula:

OCN—Z—NCO

wherein Z is an aliphatic, cycloaliphatic, aromatic, or alkylaromatic group can be reacted with a polyalcohol such as a polyether diol, a polyester diol, or combinations thereof to prepare the isocyanate-terminated polyurethane prepolymer. Examples of diisocyanates include, but are not limited to, 1,4-diisocyanatobutane, 1,6-diisocyanatohexane, 1,5-diisocyanato-2,2-dimethylpentane, 2,2,4- or 2,4,4-trimethyl-1,6-diisocyanatohexane, 1,10-diisocyanatodecane, 1,3- and 1,4-diiso-cyanatocyclo-hexane, 1-isocyanato-5-isocyanatomethyl-3,3,5-trimethylcyclohexane (isophorone diisocyanate), 2,3-, 2,4- and 2,6-diisocyanato-1-methylcyclohexane, 4,4′- and 2,4′-diisocyanatodicyclohexyl methane, 1-isocyanato-3 (4)-isocyanato methyl-1-methyl-cyclohexane, 2,4-, and 2,5- and 2,6-tolylene diisocyanate, 1,3- and 1,4-phenylene diisocyanate, 4,4′- and 2,4′-diisocyanatodiphenylmethane, 1,3-bis(1-isocyanato-1-methylethyl)benzene, dimer diisocyanate and mixtures thereof. Preferred is dicyclohexylmethane diisocyanate.

Suitable polyalcohols include one or more polyether diols, one or more polyester diols, and mixtures thereof.

Suitable polyether diols include those represented by the formula:

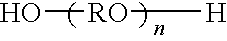

wherein R is an alkylene group with 2 to 8 carbon atoms which may be linear or branched. Preferably, R is a C₂ to C₄ alkylene group. Examples of particularly useful polyether diols include, but are not limited to, poly (ethylene ether) glycols, poly (propylene) ether glycols and poly (tetramethylene ether) glycols, with poly (tetramethylene ether) glycols being preferred. Particularly preferred is a mixture of polytetramethylene glycol and polypropylene glycol in a ratio of 50:50. The number average molecular weight of the polyether diol typically ranges from 250 to 10000, preferably from 1000 to 2500, and more preferably from 1250 to 2000. The polyether diols can also contain a minor percentage by weight, e.g., up to 40 weight percent, of ester units. These diols can be obtained, e.g., by reacting one or more of the aforesaid polyether diols with a lactone such as e-caprolactone.

Useful polyester diols include those represented by the formula:

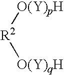

wherein
R² the residue of a diol HOR²OH, wherein R² is an alkylene group with 2 to 8 carbon atoms which may be linear or branched
Y is —OCR³COOR²⁰ in which R² has the aforestated meaning and R³ is the residue of a dicarboxylic acid HOOCR³COOH or anhydride (I) thereof, wherein R³ is an alkylene group with 2 to 8 carbon atoms which may be linear or branched and p and q independently is from 0 to 600 and preferably from 1 to 100, the sum of p+q being from 1 to 1200 and preferably from 1 to 250, or Y is —OCR⁴O— in which R⁴ is the residue of a lactone (II) or an α, ω-hydroxycarboxylic acid HOR⁴COOH and p, q and the sum of p+q have the aforestated values. Diols HOR²OH, carboxylic acids HOOCR³COOH, anhydrides (I), lactones (II) and α, ω-hydroxycarboxylic acids HOR⁴COOH that can be used herein include any of those known for preparing polyester diols. Suitable diols include ethylene glycol, propylene glycol, 1,4-butane diol, neopentyl diol, hexanediol, diethylene glycol, dipropylene glycol, and the like. Suitable dicarboxylic acids and anhydrides include adipic acid, phthalic acid, phthalic anhydride, and the like. Suitable lactones and α, ω-hydroxycarboxylic acids include butyrolactone, caprolactone, α, ω-hydroxycaproic acid and the like. Examples of particularly useful polyester diols include, but are not limited to, poly(caprolactone) diols, poly(diethylene glycol-co-ortho-phthalic acid), poly(1,6 hexanediol-co-ortho-phthalic acid), poly(neopentyl glycol-co-adipatic acid), and poly(ethylene glycol-co-adipic acid). The number average molecular weight of the polyester diol typically ranges from 250 to 10000, preferably from 500 to 2500, and more preferably from 1000 to 2000. The polyester diols can also contain ether units. In a preferred embodiment the polyester diols contain ether units in an amount of up to 40% (percentage by weight). These diols can be obtained, e.g., by reacting one or more of the aforesaid polyester diols with one or more 1,2-alkylene oxides such as ethylene oxide, propylene oxide, etc.

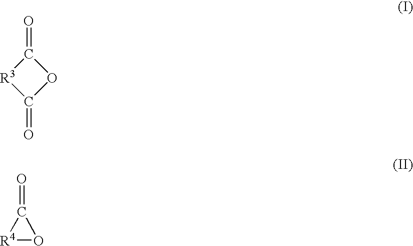

Polyether diols are desirable in terms of the product polyurethane resin having greater solubility in aliphatic alcohol solvents compared with polyester diols. However, polyester diols impart greater tensile strength to the resin. Therefore, depending on the choice of polymeric diol, the polyurethane resin obtained in accordance with the invention can vary from those resins possessing high solubility and relatively low tensile strength, i.e., those made entirely from polyether diol to those of relatively low solubility and relatively high tensile strength made entirely from polyester diol, and all of the combinations of solubility and tensile strength properties in between as would be the case where mixtures of polyether and polyester diols are employed. Optimum proportion of solubility and tensile strength can be obtained through routine testing.

The polyalcohol and diisocyanate are reacted under conditions which are well known to those skilled in the art Preferably, the reaction is carried out in the presence of a solvent, which is a solvent that is typically used in compositions formulated using the resin such as the solvent system of an ink formulation. Examples of suitable solvents in which the diisocyanate and polyalcohol can be reacted include, but are not limited to alkyl (1-5 carbon) acetates such as methyl acetate, ethyl acetate, propyl acetate, butyl acetate and pentyl acetate, with ethyl acetate being particularly preferred.

The ratio of diisocyanate to polyalcohol is selected to obtain a desired molecular weight as well as a desired level of urethane and urea segments. An excess of diisocyanate is used to ensure that the prepolymer is isocyanate terminated. The equivalent ratio of diisocyanate to diol generally ranges from 1.1-5.0 to 1.0, preferably a ratio of 1.4 to 1.0

The total amount of solvent used for preparation of the isocyanate-terminated prepolymer typically ranges from 0 to 95 percent by weight of the total solution, preferably from 20 to 90 percent by weight of the total solution, and more preferably from 55 to 80 percent by weight of the total solution.

Formation of the isocyanate-terminated prepolymer is generally carried out at a temperature ranging from 0 to 130° C., preferably from 50 to 90° C. The time of the reaction generally ranges from a period of from 1 to 12 hours, preferably from 2 to 4 hours.

The isocyanate-terminated prepolymer is then chain extended with a diol or a diamine to form a polyurethane/urea resin.

The diol or diamine can be selected from any diol or diamine which can increase the number average molecular weight of the final polyurethane resin to about 20,000 to about 120,000 daltons and the viscosity to about 500 to about 5,000 cps at 25° C. (which corresponds to 500 to about 5,000 mPa·s at 25° C.).

The diol for the chain extension reaction can be any polyol described above and low molecular weight polyol such as aliphatic diols, such as ethylene glycol, 1,2-propanediol, 1,3-propanediol, 1,3-butanediol, 1,4-butanediol, neopentylglycol, pentanediol, 3-methyl-1,5-pentanediol, hexanediol, octanediol, diethyleneglycol and triethylene glycol and alicyclic diols such as 1,3-cyclohexanediol and 1,4-cyclohexanediol. These diols can be used alone or in admixture.

The diamine can be any aliphatic, cycloaliphatic, aromatic, or heterocyclic diamine in which each of the amine groups possesses at least one labile hydrogen atom. Among the many suitable diamines are ethylene diamine, 1,2-diaminopropane, 1,3-diaminopropane, hydrazine, diaminobutane, hexamethylene diamine, 1,4-diaminocyclohexane, 3-aminomethyl-3,5,5-trimethylcyclohexylamine (isophorone diamine), 1,3-bis(aminomethyl)cyclohexane, 1,3 bis(aminomethyl)benzene, 2-(aminomethyl)-3,3,5-trimethylcyclopentylamine, bis-(4-aminocyclo-hexyl)-methane, bis-(4-amino-3-methylcyclohexyl)-methane, 1-amino-1-methyl-3(4)-aminomethyl-cyclohexane, bis-(4-amino-3,5-diethylcyclohexyl)-methane, bis-amino-methyl-hexahydro-4,7-methanoindane, 2,3-, 2,4- and 2,6-diamino-1-methyl-cyclohexane, dimer diamine (diamine from dimerized fatty acids), norbornane diamine, 2,2,4 and 2,4,4 trimethyl 1,6 hexanediamine, DuPont brand Dytek™ A and Dytek™ EB, Huntsman's Jeffamine™ brand bis(propylamino) polypropylene oxide diamines, bis(aminomethyl)tricyclodecane, piperazine, 1,3-di-piperidylpropane, aminoethylpiperazine.

The reaction of the diamine or diol with the prepolymer is carried out in the solvent or in a component of the solvent system ultimately used in the final composition formulated from the ink resin as described. The amount of solvent utilized in the chain extension reaction generally ranges from 0 to 90 percent by weight, and preferably from 35 to 60 percent by weight. The ratio of isocyanate end groups of the prepolymer to amines from the diamine monomer or the —OH of the diol determines the final polymer molecular weight of the resin as well as the level of urea/urethane groups. Generally, the mole ratio of diisocyanate to diamine or diol is from 6:1 to 1:5, preferably from 4:1 to 1:4. Typically, when the prepolymer is reacted with a stoichiometric excess of the diamine or diol, no residual unreacted isocyanate groups remain in the prepolymer. Accordingly, reaction of the chain-extended prepolymer with an amine or alcohol terminating agent to endcap unreacted isocyanate groups on the chain-extended prepolymer is not required. Alternatively, if less than a stoichiometric excess of diamine or diol is utilized, unreacted isocyanate groups may be present which can be endcapped as described below. The chain extension reaction with diamine or diol is generally carried out at a temperature ranging from 0 to 90° C., and preferably ranging from 25 to 75° C.

Following the chain extension reaction with diamine or diol, if unreacted isocyanate groups exist, some or all of the remaining isocyanate groups are preferably endcapped with an amine or alcohol to terminate the foregoing poly(urethane-urea) resin. Examples of suitable amines are monoamines and diamines including, but not limited to butylamine, dibutylamine, aminopropylmorpholine, aminoethylpiperazine, dimethylaminopropylamine, di(isopropanol)amine, aminoethoxyethanol, aminoundecanoic acid, ethanolamine, dimethanolamine,4-aminophenol, isophoronediamine, dimer diamine, oleyl amine, hydrazine, Jeffamine brand mono or bis(aminopropyl) polypropyleneoxides. Examples of suitable alcohols include, but are not limited to, 1-propanol, 2-propanol, 1-butanol, 2-butanol, neopentyl alcohol, ethanol, oleyl alcohol, 12-hydroxystearic acid, N-(hydroxyethyl)stearamide, ethoxylated nonylphenol, propoxylated nonylphenol, glycolic acid, or 6-hydroxycaproic acid.

The endcapping reaction of any remaining free isocyanate groups is carried out under conditions which are well known to those skilled in the art. Preferably, this reaction is carried out in the presence of a solvent or in a component of the solvent system ultimately used in the final composition formulated from the ink resin as described above. The total amount of solvent utilized to endcap the free isocyanate groups generally range from 0 to 90% by weight, preferably ranges from 25 to 75% by weight.

The temperature of the endcapping reaction generally ranges from 0 to 100° C., and preferably ranges from 25 to 75° C. The time of the endcapping reaction generally ranges from a period of from 0.1 to 6 hours, and preferably from 0.25 to 1 hour. The NCO-equivalent ratio of the chain-extended resin to amine or alcohol generally ranges from 5:1 to 1:5, and preferably ranges from 1:2 to 2:1.

The polyurethane resins of the present invention advantageously provide good extrusion and adhesive properties to NC-inks formulated with the resins of the invention, which inks are thus particularly suitable for use in flexible packaging applications.

The laminating NC-based ink composition of the invention comprises a nitrocellulose-based pigment or dye, the polyurethane resin of the invention; an adhesion promoter and an organic solvent. The ink composition of the invention may be used in either flexographic or gravure printing by making minor adjustments to the formulation (e.g. solvent and viscosity adjustments). In particular, the ink of the invention comprises, based on the weight of the ink: about 15 wt. % to about 50 wt. % of the polyurethane resin; about 3 wt. % to about 60 wt. % of the NC pigment or dye; about 0 wt % to about 5 wt % of the adhesion promoter and about 10 wt. % to about 80 wt. % of the organic solvent; and component concentrations may be adjusted for use in flexography or gravure printing. Preferably, the gravure ink comprises about 8 wt. % to about 60 wt. % of the polyurethane resin; about 3 wt. % to about 60 wt. % of the NC pigment or dye; about 0 wt. % to about 5 wt. % of the adhesion promoter and about 15 wt. % to about 80 wt. % of the organic solvent such as alkyl ester solvent; and the flexographic ink comprises, about 8 wt. % to about 60 wt. % of the polyurethane resin; about 3 wt. % to about 60 wt. % of the NC pigment or dye; about 0 wt % to about 5 wt % of the adhesion promoter and about 15 wt. % to about 80 wt. % of the organic solvent such as an alkanol solvent. The ink suitably has a viscosity between about 15 seconds to about 30 seconds, as measured in a Zahn 2 efflux cup. Efflux cup measurements are conventional methods for measuring ink viscosities, and involve timing the flow of a calibrated quantity of ink through a calibrated orifice. The lower viscosity inks typically are used in gravure printing and the higher viscosity inks typically are used in flexographic printing. Thus, when the ink has a viscosity of about 28 seconds at 25° C. as measured in a Zahn 2 efflux cup, it is suitable for flexographic printing; and when the ink has a viscosity of about 18 seconds as measured in a Zahn 2 efflux cup, it is suitable for gravure printing applications.

Nitrocellulose-based pigment or dye dispersions are commercially available, from, e.g., Penn Color or other suppliers. In one aspect, the present invention provides a process that includes mixing together a nitrocellulose-based pigment or dye dispersion and the polyurethane resin of the present invention. The polyurethane resin may, if desired, be pre-dissolved in a suitable solvent prior to being mixed with the nitrocellulose-based pigment or dye dispersion. Suitable solvents include, without limitation, ethanol, isopropanol, n-propanol, 1-butanol, ethyl acetate, propyl acetate and butyl acetate. The two components are mixed together until they are homogeneous, which can be readily accomplished by placing the mixture in a container, or a shaker, for about one hour.

Both pigments and dyes are suitable colorants as an image-forming component of the printing ink composition.

The polyurethane: nitrocellulose weight ratios can range from about 5:95 to about 95:5 due to the high compatibility of the polyurethane with nitrocellulose.

Because the polyurethane resins of the present invention display good adhesion to plastic film, e.g., polyethylene (PE), polypropylene (PP), polyethylene terephthalate (PET), cellulosic, polycarbonate, polyamide (PA), PVDC coated polyethylene terephthalate, PVDC coated polypropylene, metallized polyethylene terephthalate, or metallized polypropylene, and display good cohesive strength when sandwiched between two sheets of plastic film, these polyurethane resins can be incorporated into inks useful as laminating inks.

In another aspect then, the present invention provides an ink that contains the polyurethane of the invention and nitrocellulose, which ink is formulated to function as a laminating ink, as well as methods of laminating printing that utilize these inks.

Another aspect then of the invention relates to the printing of the laminating ink image wise onto a surface of a polymeric substrate and forming a dried ink image on a surface of the substrate, which image is tack-free, firmly adherent to the surface of the substrate, and un-blocked when contacted under pressure at ambient temperatures to a second surface of a substrate. Although any polymeric substrate may be printed with this method, preferred polymeric substrates include a film or sheet of polyethylene (PE), polypropylene (PP), polyethylene terephthalate (PET), cellulosic, polycarbonate, polyamide (PA), PVDC coated polyethylene terephthalate, PVDC coated polypropylene, metallized polyethylene terephthalate, or metallized polypropylene.

A second substrate may be applied or laminated to the dried ink image on the first substrate by any conventional method to form a printed laminate. Thus, the second substrate may be applied as an extruded melt onto the dried image to form the second substrate; or a preformed second substrate may be laminated to the dried ink image through an adhesive surface. The second substrate may be composed of the same material as the first substrate or it may be different depending on the nature of the end use of the printed laminate.

In general, at least one of the substrates will be translucent to visible light and, more typically, transparent. Such transparency or translucency will allow colorant to present a hue and/or resolvable image through the substrate.

The following Examples are illustrative of the present invention and should not be construed in any manner whatsoever as limiting of the scope of the invention.

### EXAMPLES

### 1. Test Methods

US units and SI units can be interconverted as follows:
125° F.=52° C.
175° F.=79° C.
325° F.=163° C.
1 g/inch=0.005791 N/15 mm
1 psi=0.0689475728 bar
1 lb/ream=1.631 g/m²

### Printing

A 165P hand proofer from Pamarco was used in printing inks onto the films.

### Tape Adhesion

The tape Scotch® 610 from 3M was stuck immediately after the prints were dried:
0%=poor ink adhesion with 100% ink coming off from the substrate
100%=excellent ink adhesion with 0% ink coming off from the substrate

### Block Resistance

Prints were folded to have ink/back and ink/ink contact. Folded prints were subjected to 52° C./2.8 bar/24 h (which corresponds to 125° F./40 psi/24 h) in an oven:
1=poor block resistance with 100% ink transfer from the print side
10=excellent block resistance with 0% ink transfer from the print side

### Adhesive Lamination

Laminate structure (example): film/ink/adhesive/film
Dry adhesive film thickness (example): 1.6-2.5 g/m² (corresponds to 1.0-1.5 lb/ream)
Lamination condition: 79° C./1.438 bar/1 sec (corresponds to 175° F./20 psi/1 sec) using a CARD/GUARD® laminator from Jackson-Hirsh Laminating

Adhesives were applied on the printed film. The coating weight and cure conditions were followed according to the adhesive manufacturer's recommendations. For the two-pack solvent-based adhesive Adcote® 812/Adcote® 811 B, a coating weight of at 3.3-4.9 g/m² dry (corresponds to 2-3 lb/ream) was applied and the laminates were cured at room temperature for 7 days. For the one-pack solvent-based adhesive Adcote® 331 a coating weight of 1.6-2.5 g/m² dry (corresponds to 2-3 lb/ream) was applied and the laminates were cured at room temperature for 3 days.

### Extrusion Lamination

Laminate structure (example): film/ink/primer/extrusion layer
Lamination condition: 163° C./1.438 bar/1 sec (corresponds to 325° F./20 psi/1 sec) using a CARD/GUARD® laminator from Jackson-Hirsh Laminating

The primer Mica 131× was diluted with 2-propanol and water and applied on the printed film with a spiral bar coater at a wet film thickness of 6 μm according to the manufacturer's recommendations. The corresponding laminates were cured at room temperature for 1 day.

### Bond Strength Test

Thwing Albert Friction/Peel tester Model 225-1, prints were supported with tape, peeled at 180° with 300 mm/min speed, values are average of 3 readings in N/15 mm.
Destruct: complete film tear during peel
FT: partial film tear during peel
Decal: 100%=all ink coming off from the printed film during peel
   0%=no ink coming off from the printed film during peel

### 2. Raw Materials

Lupranate® MI from BASF
Pluriol® P 2000® from BASF
Poly THF® 2000® from BASF
BiCat® 8 from Shepherd Chemical
Nitrocellulose A-400 (70% solids) from Bayer
Vertec® IA 10 from Johnson Matthey
Blue 15:4=Lionol Blue FG 7400 G pigment from Toyo
TR 52=Titanium dioxide pigment from Huntsman
RDE 2=Titanium dioxide pigment from Kemira
T523-3=15 μm corona pre-treated boPP film from AET Films
Mylar® 813=12 μm corona pre-treated PET from DuPont
50 μm corona pre-treated white, opaque PE film from Southern Converter
Adcote® 812/Adcote® 811 B=2-component polyurethane adhesive from Rohm & Haas
Adcote® 331=1-component polyurethane adhesive from Rohm & Haas
Mica® 131x=PEI primer from Mica Corporation
Versamid® PUR 1132 from Cognis
NeoRez® U-395 from DSM NeoResins
NeoRez® U-397 from DSM NeoResins

### 3) Polyurethane Examples

### Example Resin 1

11.61% Lupranate® MI and 34.52% Pluriol® P 1000 were reacted using 0.02% BiCAT® 8 as catalyst and 30.21% ethylacetate as solvent at 68-72° C. for 2 hours under nitrogen flow until NCO % of 1.46 was achieved. This resulted in an isocyanate-terminated prepolymer with 53.80% solids.

The prepolymer was chain extended by adding variable amounts of 1,4-butanediol. The viscosity was monitored during chain extension. When viscosity reached 20,000-30,000 mPa·s at 25° C., the addition of 1,4-butanediol was stopped and 22.6% of ethanol was added to form the final polyurethane solution.

The final polyurethane solution has viscosity of 1600 mPa·s at 25° C., solids of 46.8% and a Gardner color of less than 2.

### Example Resin 2

8.52% Lupranate® MI, 8.53% Poly THF® 2000, 25.59% Pluriol® P 2000 were reacted using 0.02% BiCAT® 8 as catalyst and 11.68% ethylacetate as solvent at 68-72° C. for 2 hours under nitrogen flow until NCO % of 2.63 was achieved. This resulted in an isocyanate terminated prepolymer with 78.5% solids.

The final polyurethane resin solution was prepared by adding the above prepolymer solution at a controlled rate 2.15% of isophorone diamine and 0.42% 1-amino-2-propanol in 35.05% ethanol and 8.03% ethylacetate.

The final polyurethane solution had a viscosity of 1390 mPa·s cps at 25° C., solids of 47.47% and a Gardner color of less than 2.

Example resins 1 and 2 of the invention were compared with commercial polyurethane resins Versamid® PUR 1132, NeoRez® U-395 and NeoRez® U-397 for performance.

### 4) Performance Examples 1-6

TABLE 1
NC-based pigment dispersion formula

| | Blue | White |
|---|---|---|
| NC Base | % | % |
| A-400 (70% solids) | 9.38 | 14.00 |
| Toyo Blue 15:4 | 26.25 | |
| RDE2/TR52 50/50 | | 49.00 |
| 1-PrOH/PrAc 80/20 | 64.37 | 37.00 |
| Total | 100.00 | 100.00 |
| Steel shots (2 mm) | 200.00 | 200.00 |
| Total | 300.00 | 300.00 |

TABLE 2
Ink formula

| Ink formula | Blue | White |
|---|---|---|
| NC base | 50.0 | 43.5 |
| Polyurethane resin | 28.0 | 36.0 |
| IA 10 | 3.0 | 3.0 |
| 1-PrOH/PrAc 80/20 | 19.0 | 17.5 |
| Total | 100.0 | 100.0 |
| Glass beads, 4 mm | 30.0 | 30.0 |

TABLE 3
Performance of white inks on BOPP film

| Laminate | printed T523/3 BOPP/adhesive or primer/PE | | | | |
|---|---|---|---|---|---|
| structure | Example | Example | Versamid ® | Neorez ® U | Neorez ® U |
| White inks | resin 1 | resin 2 | PUR 1132 | 395 | 397 |
| 610 tape | 95% | 100% | 100% | 100% | 100% |
| adhesion | | | | | |
| Block | 9 | 8 | 10 | 9 | 10 |
| resistance | | | | | |
| Adhesive | destruct | destruct | destruct | destruct | destruct |
| Lam bond | | | | | |
| strength | | | | | |
| (withtape) | | | | | |
| with Adcote | | | | | |
| 331 | | | | | |
| % decal | N/A | N/A | N/A | N/A | N/A |
| Adhesive | destruct | destruct | destruct | destruct | destruct |
| Lam bond | | | | | |
| strength | | | | | |
| (withtape) | | | | | |
| with Adcote | | | | | |
| 812-811B | | | | | |
| % decal | N/A | N/A | N/A | N/A | N/A |
| Extrusion | destruct | destruct | destruct | destruct | destruct |
| Lam bond | | | | | |
| strength (with | | | | | |
| tape) with | | | | | |
| Mica 131x | | | | | |
| % decal | N/A | N/A | N/A | N/A | N/A |

TABLE 4
Performance of blue inks on BOPP film

| Laminate | printed T523/3 BOPP/adhesive or primer/PE | | | | |
|---|---|---|---|---|---|
| structure | Example | Example | Versamid ® | Neorez ® U | Neorez ® U |
| Blue inks | resin 1 | resin 2 | PUR 1132 | 395 | 397 |
| 610 tape | 75% | 100% | 100% | 100% | 100% |
| adhesion | | | | | |
| Block | 10 | 4 | 6 | 5 | 10 |
| resistance | | | | | |
| Adhesive | destruct | destruct | destruct | destruct | destruct |
| Lam bond | | | | | |
| strength | | | | | |
| (withtape) | | | | | |
| with Adcote | | | | | |
| 331 | | | | | |
| % decal | N/A | N/A | N/A | N/A | N/A |
| Adhesive | destruct | destruct | destruct | destruct | destruct |
| Lam bond | | | | | |
| strength | | | | | |
| (withtape) | | | | | |
| with Adcote | | | | | |
| 812-811B | | | | | |
| % decal | N/A | N/A | N/A | N/A | N/A |
| Extrusion | destruct | 294 | destruct | destruct | 242 FT |
| Lam bond | | | | | |
| strength (with | | | | | |
| tape) with | | | | | |
| Mica 131x | | | | | |
| % decal | N/A | 90% | N/A | N/A | 80% |

TABLE 5
Performance of white over blue inks on BOPP film

| Laminate | | | | | |
|---|---|---|---|---|---|
| structure | printed T523/3 BOPP/adhesive or primer/PE | | | | |
| White over | Example | Example | Versamid ® | Neorez ® U | Neorez ® U |
| Blue inks | resin 1 | resin 2 | PUR 1132 | 395 | 397 |
| 610 tape | 90% | 100% | 100% | 100% | 100% |
| adhesion | | | | | |
| Block | 10 | 6 | 10 | 10 | 10 |
| resistance | | | | | |
| Adhesive Lam | destruct | destruct | 381 FT | 316 | destruct |
| bond strength | | | | | |
| (withtape) | | | | | |
| with Adcote | | | | | |
| 331 | | | | | |
| % decal | N/A | N/A | 100% | 100% | N/A |
| Adhesive Lam | destruct | destruct | destruct | destruct | destruct |
| bond strength | | | | | |
| (withtape) with | | | | | |
| Adcote 812- | | | | | |
| 811B | | | | | |
| % decal | N/A | N/A | N/A | N/A | N/A |
| Extrusion Lam | destruct | 484 FT | destruct | 527 FT | 148 |
| bond strength | | | | | |
| (with tape) | | | | | |
| with Mica | | | | | |
| 131x | | | | | |
| % decal | N/A | 90% | N/A | 100% | 90% |

TABLE 6
Performance of white inks on PET film

| Laminate | printed 48LBT PET/adhesive or primer/PE | | | | |
|---|---|---|---|---|---|
| structure | Example | Example | Versamid ® | Neorez ® U | Neorez ® U |
| White inks | resin 1 | resin 2 | PUR 1132 | 395 | 397 |
| 610 tape | 100% | 100% | 100% | 100% | 100% |
| adhesion | | | | | |
| Block | 6 | 9 | 10 | 10 | 10 |
| resistance | | | | | |
| Adhesive | 150 | 61 | 29 | 54 | 50 |
| Lam bond | | | | | |
| strength | | | | | |
| (withtape) | | | | | |
| with Adcote | | | | | |
| 331 | | | | | |
| % decal | 95% | 100% | 100% | 100% | 100% |
| Adhesive | destruct | destruct | 186 | destruct | 316 |
| Lam bond | | | | | |
| strength | | | | | |
| (withtape) | | | | | |
| with Adcote | | | | | |
| 812-811B | | | | | |
| % decal | N/A | N/A | 100% | N/A | 90% |
| Extrusion | destruct | destruct | destruct | 507 FT | 113 |
| Lam bond | | | | | |
| strength (with | | | | | |
| tape) with | | | | | |
| Mica 131x | | | | | |
| % decal | N/A | N/A | N/A | 100% | 100% |

TABLE 7
Performance of blue inks on PET film

| Laminate | printed 48LBT PET/adhesive or primer/PE | | | | |
|---|---|---|---|---|---|
| structure | Example | Example | Versamid ® | Neorez ® U | Neorez ® U |
| Blue inks | resin 1 | resin 2 | PUR 1132 | 395 | 397 |
| 610 tape | 100% | 100% | 100% | 100% | 100% |
| adhesion | | | | | |
| Block | 10 | 6 | 9 | 7 | 10 |
| resistance | | | | | |
| Adhesive | destruct | 170 | 36 | 97 | 65 |
| Lam bond | | | | | |
| strength | | | | | |
| (withtape) | | | | | |
| with Adcote | | | | | |
| 331 | | | | | |
| % decal | N/A | 100% | 100% | 100% | 100% |
| Adhesive | destruct | destruct | 149 | destruct | destruct |
| Lam bond | | | | | |
| strength | | | | | |
| (withtape) | | | | | |
| with Adcote | | | | | |
| 812-811B | | | | | |
| % decal | N/A | N/A | 100% | N/A | N/A |
| Extrusion | destruct | 211 | 48 | 75 | 28 |
| Lam bond | | | | | |
| strength (with | | | | | |
| tape) with | | | | | |
| Mica 131x | | | | | |
| % decal | N/A | 90% | 100% | 100% | 100% |

TABLE 8
Performance of white over blue inks on PET film

| Laminate | | | | | |
|---|---|---|---|---|---|
| structure | printed 48LBT PET/adhesive or primer/PE | | | | |
| White over | Example | Example | Versamid ® | Neorez ® U | Neorez ® U |
| Blue inks | resin 1 | resin 2 | PUR 1132 | 395 | 397 |
| 610 tape | 100% | 100% | 100% | 100% | 100% |
| adhesion | | | | | |
| Block | 10 | 6 | 10 | 8 | 10 |
| resistance | | | | | |
| Adhesive Lam | destruct | 51 | 28 | 33 | 35 |
| bond strength | | | | | |
| (withtape) | | | | | |
| with Adcote | | | | | |
| 331 | | | | | |
| % decal | N/A | 100% | 100% | 100% | 100% |
| Adhesive Lam | destruct | 133 | 47 | 86 | 64 |
| bond strength | | | | | |
| (withtape) with | | | | | |
| Adcote 812- | | | | | |
| 811B | | | | | |
| % decal | N/A | 100% | 100% | 100% | 100% |
| Extrusion Lam | destruct | 55 | 50 | 59 | 33 |
| bond strength | | | | | |
| (with tape) | | | | | |
| with Mica | | | | | |
| 131x | | | | | |
| % decal | N/A | 90% | 100% | 100% | 90% |

As can be seen from the data above for Example resins 1 and 2 of the invention, the lamination bond strengths of the NC-polyurethane inks for adhesive lamination and extrusion lamination were higher than the inks containing the commercial polyurethane resins Versamid® PUR 1132, NeoRez® U-395 and NeoRez® U-397.

What is claimed is:

1. A method of preparing a nitrocellulose-based ink for laminated packaging applications, comprising adding to an ink base, a polyurethane resin, which resin comprises the reaction product of a polyisocyanate and a polyalcohol to form an isocyanate-terminated prepolymer, which prepolymer is chain extended with a diol or a diamine to form the polyurethane resin, wherein said polyurethane resin is compatible with nitrocellulose and has adhesive properties which provide a lamination bond strength of greater than about 200 g/inch when peeled at 300 mm/min.

2. The method of claim 1 wherein said polyalcohol comprises one or more members selected from the group consisting of polyether diols, polyester diols, and combinations thereof.

3. The method of claim 2 wherein said polyether diol comprises a compound of the formula: 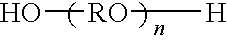
wherein R is a C₂ to C₈ straight chain or branched hydrocarbon group.

4. The method of claim 3 wherein R comprises a C₂-C₄ alkylene group.

5. The method of claim 2 wherein said polyether diol comprises polypropylene glycol.

6. The method of claim 2 wherein said polyester diol is selected from the group consisting of poly(caprolactone) diols, poly(diethylene glycol-co-ortho-phthalic acids), poly(1,6-hexane diol-co-ortho-phthalic acids), poly(neopentyl glycol-co-adipatic acids), poly(ethylene glycol-co-adipic acids) and combinations thereof.

7. A nitrocellulose-based ink composition for laminated packaging applications, which ink composition comprises:
(a) at least one polyurethane resin comprising the reaction product of a polyisocyanate and a polyalcohol to form an isocyanate-terminated prepolymer, which prepolymer is chain extended with a diol or a diamine to form the polyurethane resin, wherein said polyurethane resin is compatible with nitrocellulose and has adhesive properties which provide a lamination bond strength of greater than about 200 g/inch when peeled at 300 mm/min;
(b) at least one nitrocellulose-based pigment or dye; and
(c) at least one organic solvent.

8. A laminate for use in packaging applications, which laminate comprises at least two polymeric substrates having a surface of one of said substrates printed with the ink composition of claim 7 to form a printed image on said substrate, said laminate having a lamination bond strength of greater than about 200 g/inch when peeled at 300 mm/min.
